(19) United States
(12) Patent Application Publication
(10) Pub. No.: US 2009/0158146 A1
(43) Pub. Date: Jun. 18, 2009

(54) RESIZING TAG REPRESENTATIONS OR TAG GROUP REPRESENTATIONS TO CONTROL RELATIVE IMPORTANCE

(75) Inventors: Scott Curtis, Durham, NC (US); Hugh Svendsen, Chapel Hill, NC (US)

Correspondence Address: WITHROW & TERRANOVA CT, 100 REGENCY FOREST DRIVE , SUITE 160, CARY, NC, 27518, US

(73) Assignee: CONCERT TECHNOLOGY CORPORATION, Durham, NC (US)

(21) Appl. No.: 11/955,534

(22) Filed: Dec. 13, 2007

(51) Int. Cl. G06F 3/00

(52) U.S. Cl. 715/700

(57) ABSTRACT

A method and system are provided for enabling a user to control or adjust importance levels assigned to tags by manipulating corresponding tag representations or a tag group representation displayed to the user. In one embodiment, tag representations for a number of tags are displayed to a user. The tags are generally any criterion used to describe or classify digital content. In one embodiment, the user is enabled to resize, or otherwise manipulate, the tag representations to thereby adjust the importance level of the corresponding tags. In another embodiment, tags are classified into at least one tag group. A tag group representation corresponding to the tag group is displayed to the user. The user is then enabled to resize, or otherwise manipulate, the tag group representation to thereby adjust an importance level of each of the tags in the tag group.

### FIELD OF THE INVENTION

The present invention relates to tags for classifying digital content and more particularly relates to adjusting an importance level assigned to a tag.

### BACKGROUND OF THE INVENTION

The amount of content available in today's online digital world is enormous. As such, tags have emerged as a means for classifying digital content. A tag may be any criterion, such as a textual descriptor, describing digital content. Tags are generally stored in association with digital content. For example, for some digital picture formats, tags are stored within the headers of the digital picture files. Tags may also be stored in an application file associated with the digital content. For example, tags describing videos accessible via an online video sharing website such as YouTube may be stored in an associated database, stored in an associated application file, or otherwise associated with the videos. Various types of information may be provided by tags depending on the particular implementation. For example, for a digital song, the associated tags may include a genre tag identifying the genre of the song, an artist tag identifying the artist of the song, an album tag identifying the album on which the song was released, a date tag identifying a date of release of the song, and the like. As another example, for a digital picture, the associated tags may include a date tag indicating the date on which the digital picture was captured, camera tags identifying various characteristics and settings of the camera that captured the digital picture, a keyword tag containing a textual descriptor of the digital picture, or the like.

Tags can be used for various purposes. For example, commonly owned and assigned U.S. patent application Ser. No. 11/484,130, entitled P2P NETWORK FOR PROVIDING REAL TIME MEDIA RECOMMENDATIONS, which was filed on Jul. 11, 2006 and is hereby incorporated herein by reference in its entirety, discloses a social recommendation system where media items recommended to a user are scored based on weights, or relative importance levels, assigned to a number of tags including, for example, genre tags. As another example, websites such as the Flickr® photo-sharing website enable users to search for desired content using tags. In many applications using tags, it is often desirable to assign weights or importance levels to various tags. However, assigning importance levels to a large number of tags can be tedious and time consuming. Thus, there is a need for a system and method for adjusting importance levels assigned to tags in an intuitive and efficient manner.

### SUMMARY OF THE INVENTION

The present invention relates to enabling a user to control or adjust importance levels assigned to tags by manipulating corresponding tag representations or a tag group representation displayed to the user. In one embodiment, tag representations for a number of tags are displayed to a user. The tags are generally any criterion used to describe or classify digital content. Preferably, the tag representations are text-based representations of the corresponding tags. In one embodiment, a size of each of the tag representations is a function of an importance level of the corresponding tag. Thus, a tag representation of a relatively important tag is larger than a tag representation of a relatively unimportant tag. The user is then enabled to resize the tag representations to thereby adjust the importance level of the corresponding tags. In one embodiment, the user is enabled to resize tag representations using a click-and-drag operation.

In another embodiment, tags are first classified into at least one tag group. A tag group representation corresponding to the tag group is displayed to the user. The user is then enabled to resize the tag group representation to thereby adjust an importance level of each of the tags in the tag group. Thus, via a single resizing operation, the user is enabled to adjust the importance level of each of an entire group of tags, an importance level of the tag group relative to other tag groups, or both. In addition, the tag group representation may include tag representations for each tag in the tag group. The user may be enabled to resize the tag representations in order to adjust the importance levels of the tags in the tag group individually.

The importance levels of the tags or tag groups may be used for any desired purpose. For example, the importance levels of the tags and/or tag groups may be used to search for digital content of interest to the user or recommend digital content to the user. As another example, the importance levels of the tags or tag groups may correspond to weights used to score media items such as songs or videos. More specific examples would be to score songs in a user's playlist as a function of the weights assigned to a number of music genres, music artists, decades of release, or the like, or any combination thereof. The songs in the playlist may then be sorted based on score. Another specific example would be to score a number of media items available to a user from a media distribution service such as Apple's iTunes® Store and then make recommendations to the user based on the scores. As a final example, the importance levels of the tags and/or tag groups may be part of a user profile. Other users having similar likes and dislikes as the user may then be identified using a profile matching technique.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a flow chart illustrating a process for presenting tag representations of tags to a user and enabling the user to adjust importance levels of the tags by manipulating the tag representations according to a first embodiment of the present invention;

FIGS. 2A through 2D illustrate an exemplary Graphical User Interface (GUI) for presenting tag representations to a user and enabling the user to manipulate the tag representations according to the first embodiment of the present invention;

FIG. 3 is a flow chart illustrating a process for presenting a tag group representation of a group of tags to a user and enabling the user to adjust importance levels of the group of tags by manipulating the tag group representation and, optionally, individual tag representations according to a second embodiment of the present invention;

FIGS. 4A through 4C illustrate an exemplary GUI for presenting tag group representations to a user and enabling the user to manipulate the tag group representations according to the second embodiment of the present invention; and

FIG. 5 illustrates an exemplary system operating according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention relates to a method enabling a user to control importance levels of tags by manipulating corresponding tag representations or tag group representations displayed to the user. Note that while the discussion herein focuses on resizing tag representations, the present invention is not limited thereto. Other forms of manipulation may be used. For example, the user may be enabled to adjust an importance level assigned to a tag by changing a color of a corresponding tag representation, changing a font of a corresponding text-based tag representation, or the like. Numerous additional alternatives will be apparent to one of ordinary skill in the art upon reading this disclosure and are to be considered within the scope of the present invention.

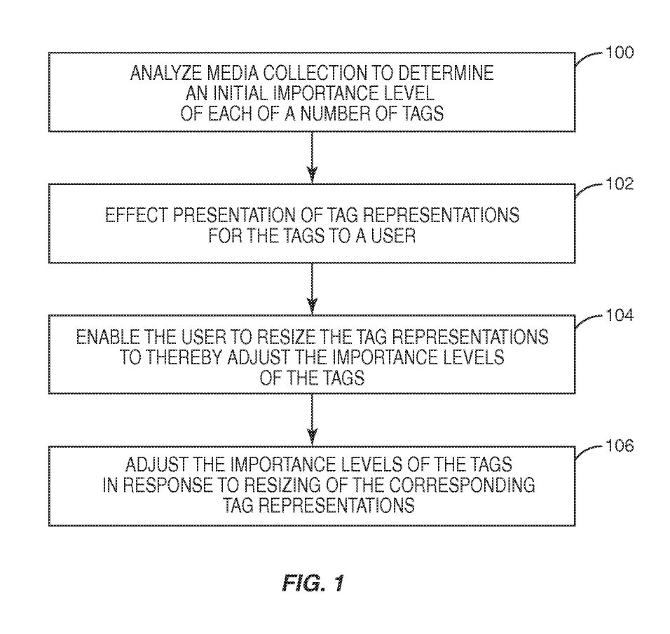

FIG. 1 is a flow chart illustrating a process for adjusting an importance level assigned to one or more tags according to a first embodiment of the present invention. As used herein, a tag is any criterion, such as but not limited to a textual descriptor, used to describe or classify digital content. The types of tags may vary depending on the type of digital content. The digital content may be, for example, music such as songs or albums; videos such as movies, episodes of television shows, video clips, or home movies; pictures; web-pages; web-sites; documents; or the like. As an example, tags for a song may include, but are not limited to, a music genre tag indicative of a music genre of the song, a music sub-genre tag indicative of a music sub-genre of the song, a music artist tag indicative of a music artist of the song, a decade or other time period tag indicative of a decade or time period in which the song was released, or the like, or any combination thereof. As another example, tags for a picture may include, but are not limited to, camera tags identifying various features and settings of a camera that captured the picture, a date tag identifying a date of capture of the picture, a keyword tag providing a textual-description of the content of the picture, a location tag identifying a location at which the picture was captured, and the like. Another exemplary type of tag is a source tag identifying or describing a source of the associated content, which may be a user, a website, or the like. Further, while importance levels are generally referred to herein as being numerical values, the present invention is not limited thereto. The importance levels may be any type of relative value. For example, as an alternative to numerical values, the importance values may be “high,” “medium,” and “low.”

First, a media collection of a user may be analyzed in order to determine an initial importance level for each of a number of tags (step 100). Step 100 is optional and is not necessary for the present invention. Alternatively, the importance levels for the tags may be set to some default value. The media collection may include a number of media items such as songs and videos. The media collection may be analyzed to determine a number of media items or a percentage of the media items in the media collection associated with or satisfying each of the tags. For example, if the media collection is a number of songs and the tags are a number of music genre tags, the media collection may be analyzed to determine a number of the songs or a percentage of the songs in the media collection classified in each of the music genres. Based on the results of the analysis, an initial importance level for each of the tags is determined.

Next, tag representations for the tags are presented, or displayed, to the user (step 102). The tag representations are preferably text-based visual representations of the tags. In this embodiment, a size of a tag representation is indicative of an importance level of the tag. The size of the tag representation and the importance level of the tag may be implemented as two separate values. Alternatively, the size of the tag representation and the importance level of the tag may be implemented as a single value. As an example, a tag for the Rock music genre may have a corresponding text-based tag representation “Rock” that is presented to the user where the size or font size of the tag representation is indicative of the importance level of the Rock music genre with respect to other tags for the user. In one embodiment, the initial size of each of the tag representations is set as a function of, or is alternatively equivalent to, the initial importance level of the corresponding tag. Otherwise, the initial importance level of each of the tags, and thus the size of the corresponding tag representation, may be set to a default value.

Note that since step 100 is optional, the user may be enabled to select or otherwise define a number of tags to be presented to the user. Initially, the tags may be assigned a default importance level, and, as such, the tag representations presented to the user may have corresponding default sizes.

The user is then enabled to resize the tag representations to thereby adjust the importance levels of the corresponding tags (step 104). Again, note that the present invention is not limited to resizing the tag representations. The user may be enabled to otherwise manipulate the tag representations to thereby adjust the importance levels of the corresponding tags. In one embodiment, the user is enabled to resize the tag representations via a click-and-drag operation where the user clicks on a desired tag representation using a mouse, touch screen, or similar pointing device and drags the desired tag representation to a size indicative of a desired importance level to be assigned to the corresponding tag. Note that the click-and-drag operation is exemplary. Other resizing techniques may be used. For example, a sliding bar or dial may be used to adjust the size of a tag representation. As another example, on a Microsoft Windows based system, the user may right-click on the desired tag representation and select a desired size or importance level from a menu.

Lastly, the importance levels assigned to the tags are adjusted in response to any resizing of the corresponding tag representations (step 106). In one embodiment, the size of a tag representation can be directly translated into an importance level. For example, if the range of possible importance levels is one through ten (1-10) and the user resizes a tag representation from a size that is 50% of a maximum size to a size that is 70% of the maximum size, the importance level of the corresponding tag may be increased from an importance level of five (5) to an importance level of seven (7). In another embodiment, the importance level of a tag and the size of the corresponding tag representation are implemented as a single value. Upon reading this disclosure, one of ordinary skill in the art will appreciate that there are other techniques for translating the sizes of the tag representations into importance levels and vice versa. The present invention is not limited to any one technique.

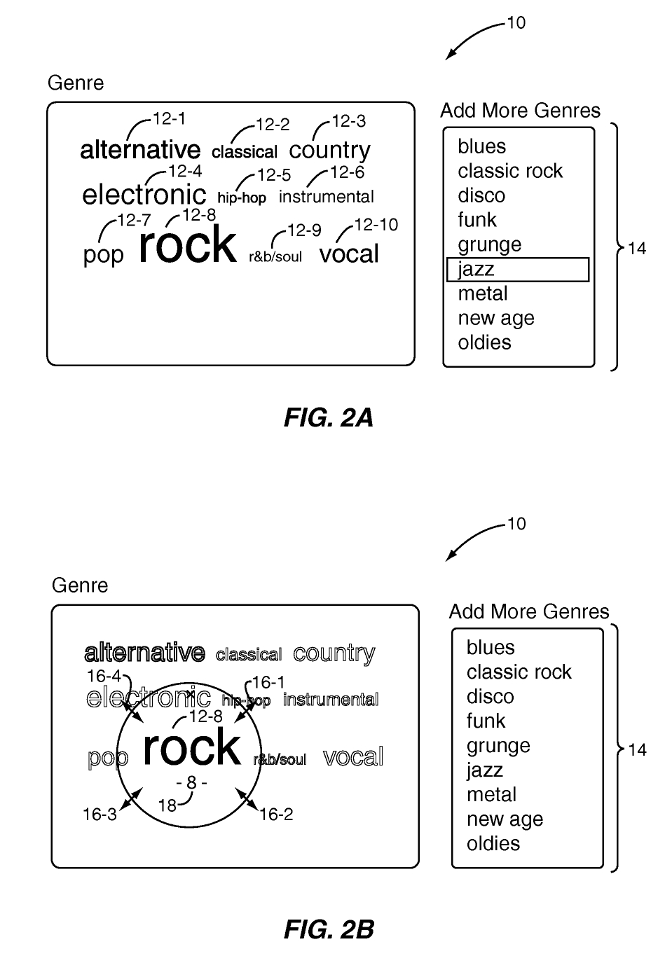

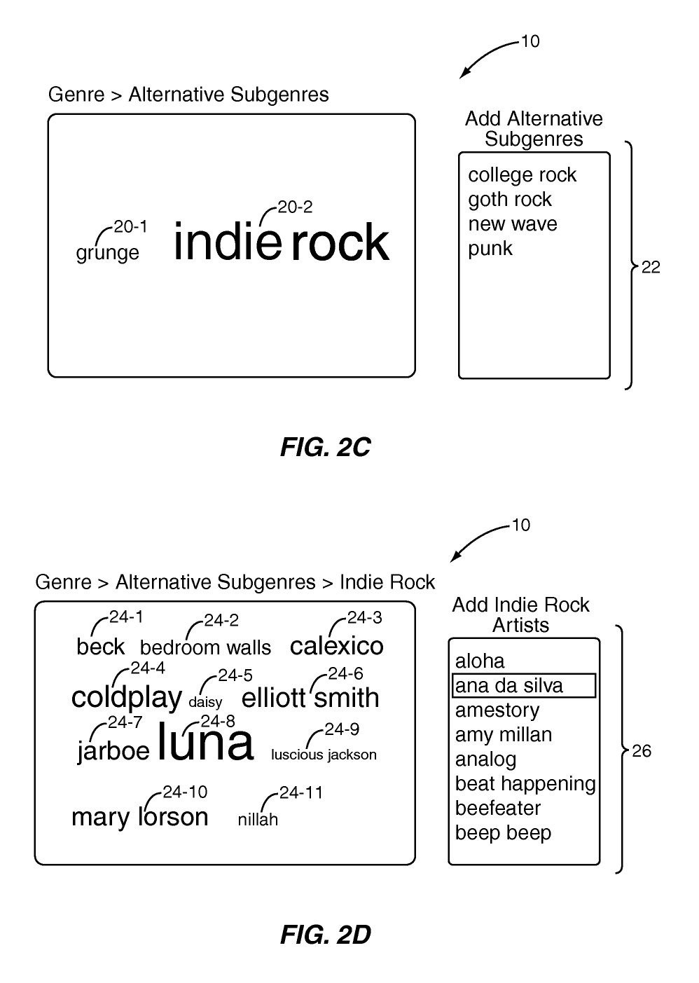

FIGS. 2A through 2D illustrate an exemplary Graphical User Interface (GUI) 10 for presenting tag representations to a user and enabling the user to resize the tag representations in order to adjust the importance levels assigned to corresponding tags according to the first embodiment of the present invention. As shown in FIG. 2A, the GUI 10 includes a number of tag representations 12-1 through 12-10. In this embodiment, each of the tag representations 12-1 through 12-10 is a text-based tag representation of a corresponding tag. However, the present invention is not limited thereto. Further, the corresponding tags are music genres. A size or font size of each of the tag representations 12-1 through 12-10 is indicative of an importance level of the corresponding tag. Thus, in this example, the tag “rock” is more important than the tag “alternative,” and the tag “alternative” is more important than the tag “classical.” In addition, the GUI 10 includes a genre list 14, which includes a list of all genres known to the system or a list of all genres known to the system for which a tag representation is not currently presented. The user may select one or more genres from the genre list 14 in order to add a corresponding tag representation to the GUI 10. For example, the user may select the genre tag “jazz.” A new tag representation “jazz” may then be presented to the user via the GUI 10. An importance level of the tag “jazz” and thus the size of the tag representation “jazz” may be set to, for example, a default value.

As illustrated in FIG. 2B, the user is enabled to resize the tag representations 12-1 through 12-10 to thereby adjust the importance levels of the corresponding tags. In this example, the user has chosen to resize the “rock” tag representation 12-8 by, for example, clicking on, or otherwise selecting, the tag representation 12-8 using a mouse, touch-screen display, or similar pointing device. The user may then resize the tag representation 12-8 using a dragging operation. More specifically, in this example, the user may click on, or otherwise select, one of a number of boundary indicators 16-1 through 16-4 and drag the selected boundary indicator outward to increase the size of the “rock” tag representation 12-8 or inward to decrease the size of the “rock” tag representation 12-8.

A size/importance level indicator 18 (hereinafter referred to as indicator 18) may be presented in association with the tag representation 12-8 during the resizing operation. The indictor 18 may provide a size of the tag representation 12-8 or an importance level of the corresponding tag. Note that the size of the tag representation 12-8 and the importance level of the corresponding tag may be implemented such that they are represented by separate values or both represented by a single value. Thus, the value “8” presented by the indicator 18 may be the size of the tag representation 12-8, the importance level of the corresponding tag, or both the size of the tag representation 12-8 and the importance level of the corresponding tag.

FIGS. 2C and 2D illustrate an optional feature of the GUI 10 enabling the user to explore nested tags and adjust importance levels of the nested tags. FIG. 2C illustrates the GUI 10 where the user has selected the “alternative” tag representation 12-1 (FIG. 2A) in order to explore nested tags associated with the “alternative” genre, which in this example are sub-genres. The nested tags enable the user to more finely define his or her preferences. The user may select the “alternative” tag representation 12-1 by, for example, double-clicking on the “alternative” tag representation 12-1. In response, tag representations 20-1 and 20-2 of a number of sub-genres of the “alternative” genre are presented to the user. As discussed above, the user may resize the tag representations 20-1 and 20-2 to thereby adjust the importance levels assigned to the corresponding sub-genres.

In addition, the GUI 10 includes a sub-genre list 22, which includes a list of all sub-genres for the alternative genre known to the system or a list of all sub-genres for the alternative genre known to the system for which a tag representation is not currently presented. The user may select one or more sub-genres from the sub-genre list 22 in order to add a corresponding tag representation to the GUI 10. For example, the user may select the sub-genre tag “college rock.” A new tag representation for “college rock” may then be presented to the user via the GUI 10. An importance level of the “college rock” tag and thus the size of the “college rock” tag representation may be set to, for example, a default value.

FIG. 2D illustrates the GUI 10 where the user has selected the “indie rock” tag representation 20-8 of FIG. 2C in order to explore nested tags associated with the “indie rock” sub-genre, which in this example are artists. Note that genres and sub-genres may be referred to herein generically as “genres.” The user may select the “indie rock” tag representation 20-8 by, for example, double-clicking on the “indie rock” tag representation 20-8. In response, a number of tag representations 24-1 through 24-11 of a number of artist tags in the “indie rock” sub-genre are presented to the user. As discussed above, the user may resize the tag representations 24-1 through 24-11 to thereby adjust the importance levels assigned to the corresponding artists.

The GUI 10 may include an artist list 26, which includes a list of all artists, or artist tags, for the indie rock sub-genre known to the system or a list of all artists for the indie rock sub-genre known to the system for which a tag representation is not currently presented. The user may select one or more artists from the artist list 26 in order to add a corresponding tag representation to the GUI 10. For example, the user may select the artist “ana da silva.” A new tag representation for “ana da silva” may then be presented to the user via the GUI 10. An importance level of the “ana da silva” tag and thus the size of the “ana da silva” tag representation may be set to, for example, a default value.

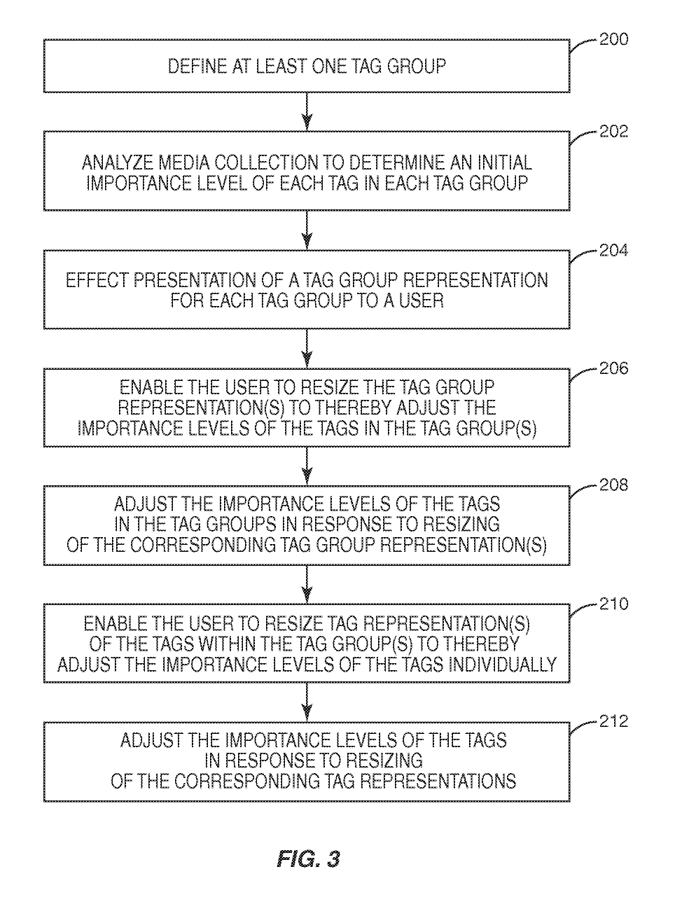

FIG. 3 is a flow chart illustrating a process for adjusting an importance level of tags in at least one tag group according to a second embodiment of the present invention. First, at least one tag group is defined (step 200). For the following discussion, it is assumed that there are two or more tag groups. However, it should be appreciated that there may be any number of one or more tag groups. As used herein, a tag group is a group of two or more tags. The tag groups may be system-defined or user-defined. For example, a tag group may be two or more genres, two or more sub-genres, two or more artists, two or more time periods or decades, a mixture of genres, sub-genres, and artists, or the like. Again, note that the types of tags may vary depending on the type of digital content.

Optionally, once the tag groups are defined, a media collection of the user may be analyzed in order to determine an initial importance level for each of the tag groups and, optionally, each of the tags in the tag groups (step 202). Again, step 202 is optional and is not necessary for the present invention. The media collection may include a number of media items such as songs and videos. More specifically, the media collection may be analyzed to determine a number of media items or a percentage of the media items in the media collection associated with or satisfying each of the tag groups. For example, if the media collection is a number of songs and the tags in a tag group are a number of music genres, the media collection may be analyzed to determine a number of the songs or a percentage of the songs in the media collection classified in one of the music genres forming the tag group. Based on the results of the analysis, an initial importance level for each of the tag groups is determined. In addition, an initial importance level for each of the tags in each of the tag groups may be set based on a similar analysis of the media collection.

Next, tag group representations for the tag groups are presented, or displayed, to the user (step 204). The tag group representations are preferably tag clouds. As used herein, a tag cloud is a visual grouping of tag representations for tags in a tag group. In this embodiment, a size of a tag group representation is indicative of an importance level assigned to the tag group. Preferably, the tag representations within the tag group representation are text-based tag representations having sizes indicative of the importance levels of the corresponding tags. In one embodiment, the initial size of each of the tag group representations is set as a function of the initial importance level of the corresponding tag group or an aggregate of the importance levels of the tags in the tag group. Otherwise, the initial importance level of each of the tag groups, and thus the size of the corresponding tag group representation, may be set to a default value. Likewise, the initial size of each tag representation within each tag cloud may be set as a function of the initial importance level of the corresponding tag. Otherwise, the initial importance level of each tag, and thus the size of the corresponding tag representation, may be set to a default value.

The user is then enabled to resize the tag group representations to thereby adjust the importance levels of the corresponding tags in the tag groups (step 206). Again, while the user is enabled to resize the group representations in this embodiment, the present invention is not limited thereto. The user may be enabled to otherwise manipulate the tag group representations to thereby adjust the importance levels of the corresponding tag groups. In one embodiment, the user is enabled to resize the tag group representations via a click-and-drag operation where the user clicks on a desired tag group representation using a mouse, a touch-screen, or similar pointing device and drags the desired tag group representation to a size indicative of an importance level to be assigned to the corresponding tag group. Note that the click-and-drag operation is exemplary. Other resizing techniques may be used.

Lastly, the importance levels of the tags in the tag groups are adjusted in response to any resizing of the corresponding tag group representations (step 208). Thus, via a single resizing operation, the user is enabled to adjust the importance level of each of the tags in the corresponding tag group. In one embodiment, each of the tags in a tag group is assigned a raw importance level. The raw importance levels of the tags in the tag group are then scaled as a function of the size of the tag group representation in order to provide the final importance levels for the tags in the tag group. For example, assume that the size of a tag group representation can be in the range of one through ten (1-10) and the tag group includes a tag “country” having a raw importance level of six (6). When the size of the group tag is ten (10), the final importance level of the “country” tag is six (6×10/10=6). If the group tag is resized to a size of five (5), then the final importance level of the “country” tag is scaled to three (6×5/10=3).

Optionally, the user may also be enabled to resize the tag representations of the tags within the tag groups individually (step 210). The importance levels of the tags are then adjusted in response to resizing of the corresponding tag representations (step 212). As discussed above, in one embodiment, the tags in a tag group are assigned raw importance levels. The raw importance levels are scaled as a function of the size of the tag group representation to provide the final importance levels of the tags. Thus, in this embodiment, the raw importance levels of the tags are adjusted in response to resizing of the corresponding tag representations. Returning to the example above, if the user resizes the “country” tag representation individually, the raw importance level of the “country” tag is adjusted. Thereafter, if the tag group representation is resized, the final importance level of the “country” tag is provided as a function of the adjusted raw importance level of the “country” tag and the size of the tag group representation.

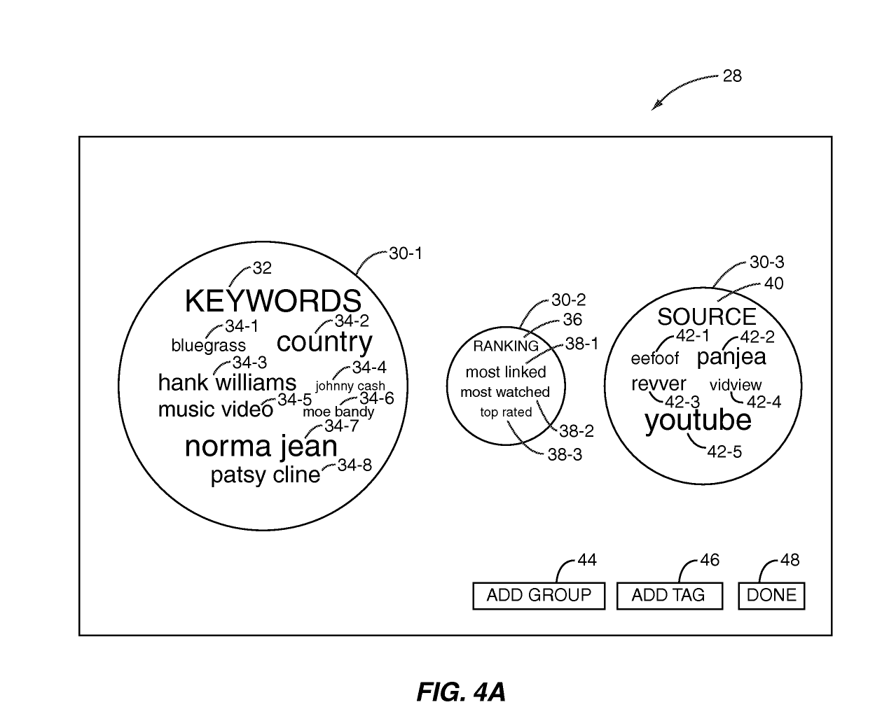

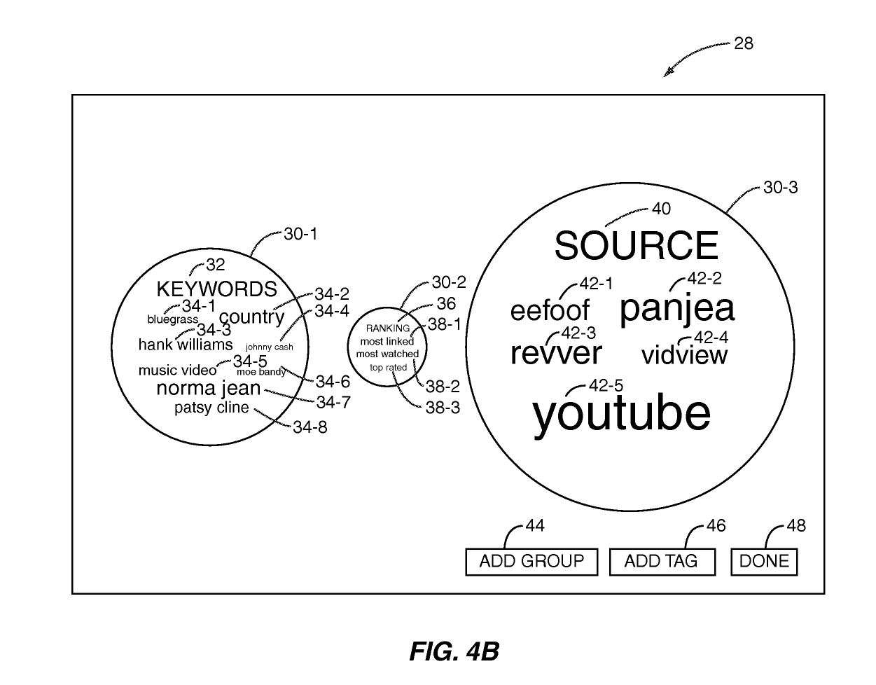

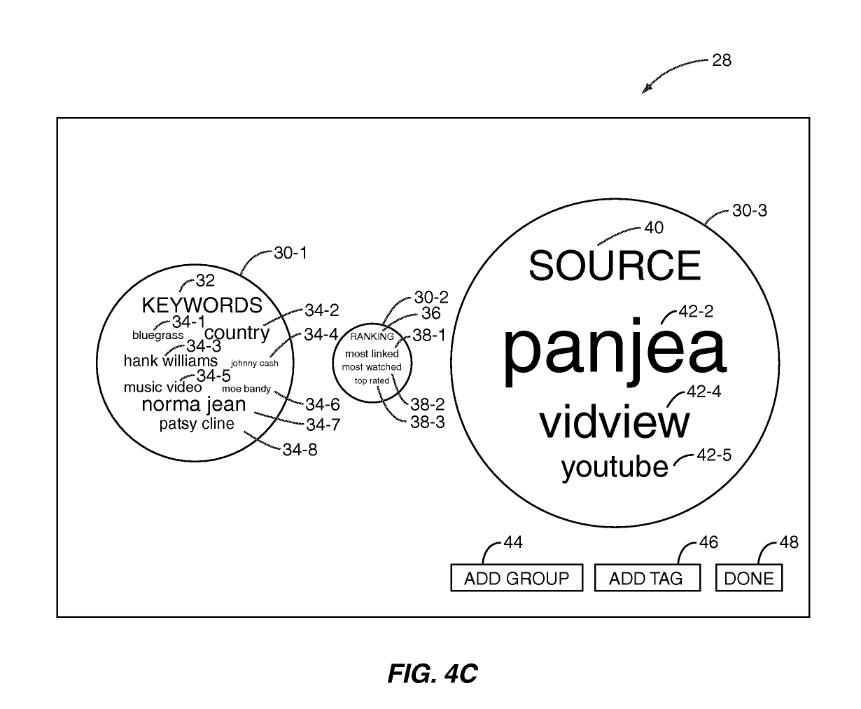

FIGS. 4A through 4C illustrate a GUI 28 in which a number of tag group representations 30-1 through 30-3 are presented to a user and which enables the user to resize the tag group representations 30-1 through 30-3 to thereby adjust the importance levels of the tags within the tag groups. More specifically, FIG. 4A illustrates the GUI 28 at an initial state. The GUI 28 includes the tag group representations 30-1 through 30-3, which are shown as tag clouds. The tag group representation 30-1 includes a title 32 and a number of tag representations 34-1 through 34-8 of tags within the corresponding tag group. The tag group representation 30-2 includes a title 36 and a number of tag representations 38-1 through 38-3 of tags within the corresponding tag group. The tag group representation 30-3 includes a title 40 and a number of tag representations 42-1 through 42-5 of tags within the corresponding tag group. In addition, the GUI 28 may include other features such as, for example, an add group button 44 enabling the user to add a tag group, an add tag button 46 enabling the user to add a tag to one of the tag groups, and a done button 48 which may be activated by the user to close the GUI 28.

In the illustrated example, the tag group representations 30-1 through 30-3 are a “keywords” tag group, a “ranking” tag group, and a “source” tag group. Such tag groups may be used to, for example, search the various sources for digital content satisfying the keyword tags in the “keywords” tag group and the rankings tags in the “rankings” tag group. The results of the search may then be scored or otherwise prioritized as a function of the importance levels of the tags in the tag groups. Note that the tag groups illustrated in FIGS. 4A through 4C are exemplary and are not intended to limit the scope of the present invention.

FIG. 4B illustrates the GUI 28 after the tag group representations 30-1 through 30-3 have been resized by the user. As illustrated, the size of the “keywords” tag group representation 30-1 has been increased. As such, the importance level of the corresponding tag group, and thus the tags represented by the tag representations 34-1 through 34-8, has increased. Note that the size of the tag representations 34-1 through 34-8, and thus the importance levels of the corresponding tags, has been scaled as a function of the resizing of the “keywords” tag group representation 30-1. Thus, the importance levels of all of the tags within the tag group have been adjusted using a single resizing operation on the “keywords” tag group representation 30-1.

Similarly, the size of the “ranking” tag group representation 30-2 has been decreased. As such, the importance level of the corresponding tag group, and thus the tags represented by the tag representations 38-1 through 38-3, has decreased. Lastly, the size of the “source” tag group representation 30-3 has been increased. As such, the importance level of the corresponding tag group, and thus the tags represented by the tag representations 42-1 through 42-5, has been increased.

FIG. 4C illustrates additional features that may optionally be provided by the GUI 28. First, the user may be enabled to delete or remove tags from a tag group. In this example, the user has deleted the tags “eefoof” and “revver” from the “source” tag group. As a result, the corresponding tag representations 42-1 and 42-3 no longer appear within the “source” tag group representation 30-3. Second, the GUI 28 also enables the user to resize the tag representations 34-1 through 34-8, 38-1 through 38-3, and 42-1 through 42-5 within the tag group representations 30-1 through 30-3. As such, the user is enabled to resize the tag group representations 30-1 through 30-3 to adjust the weights of the corresponding tags in a group-wise fashion. In addition, the user is enabled to resize the tag representations 34-1 through 34-8, 38-1 through 38-3, and 42-1 through 42-5 to adjust the weights of the corresponding tags individually. In this example, the user has increased the size of the “panjea” tag representation 42-2, increased the size of the “vidview” tag representation 42-4, and decreased the size of the “youtube” tag representation 42-5. As a result, the importance level of the “panjea” tag has increased, the importance level of the “vidview” tag has increased, and the importance level of the “youtube” tag has decreased.

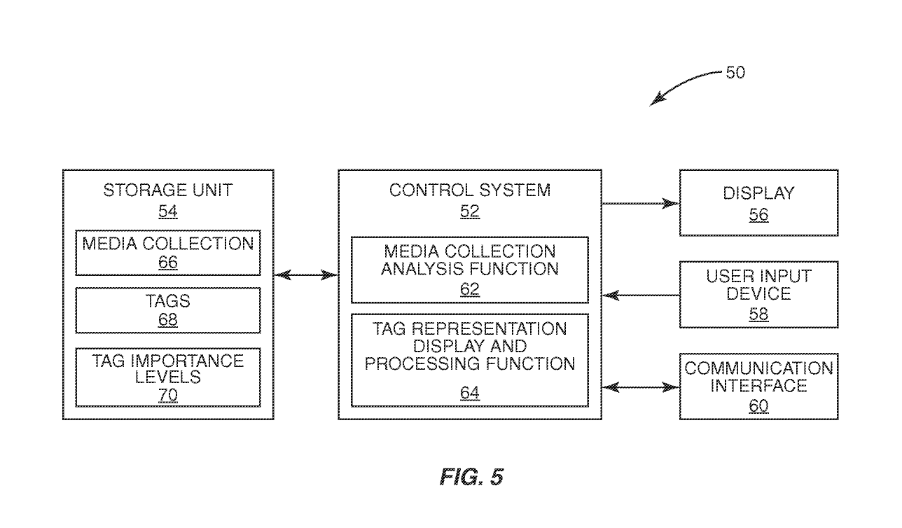

FIG. 5 illustrates an exemplary system 50 enabling a user to adjust the importance levels of tags by resizing or otherwise manipulating corresponding tag representations and/or tag group representations according to the present invention. In general, the system 50 may be any type of computing device such as, for example, a personal computer, portable media player, mobile terminal such as an Apple iPhone, server, or the like. The system 50 includes a control system 52, a storage unit 54, an associated display 56, a user input device 58, and optionally a communication interface 60. Note that the display 56 and the user input device 58 may be implemented in a single device such as a touch-screen display.

The control system 52 includes a media collection analysis function 62 and a tag representation display and processing function 64, each of which may be implemented in software, hardware, or a combination thereof. Note that the media collection analysis function 62 is optional. The storage unit 54 may be, for example, one or more hard disk drives, internal or removable memory such as Random Access Memory (RAM), or the like. In this embodiment, the storage unit 54 generally operates to store a media collection 66 of an associated user, a number of tags 68 used to describe or classify the media items in the media collection 66, and importance levels 70 assigned to the tags 68. Note that if tag groups are desired, the storage unit 54 may also store information defining each of the tag groups.

In operation, the media collection analysis function 62 operates to analyze the media collection 66 of the user with respect to the tags 68. For example, the results of the analysis may be a number of media items from the media collection 66 or a percentage of the media items from the media collection 66 satisfying each of the tags 68. The media collection analysis function 62 then sets the importance levels 70 of the tags 68 to initial values as a function of the results of the analysis.

The tag representation display and processing function 64 operates to present tag representations and/or tag group representations to the user via the display 56. For example, the tag representation display and processing function 64 may generate and present the GUI 10 of FIGS. 2A through 2D or the GUI 28 of FIGS. 4A through 4C. The user may then resize the tag representations and/or the tag group representations using the user input device 58. In response to the resizing of a tag representation, the tag representation display and processing function 64 adjusts the importance level 70 of the corresponding tag 68. Likewise, in response to the resizing of a tag group representation, the tag representation display and processing function 64 adjusts the importance levels 70 of the corresponding tags 68 in the tag group. Note, however, that the importance level 70 of each of the tags 68 in a tag group may alternatively be implemented as two values: a tag group importance level and an individual tag importance level.

The communication interface 60 is optional and may be desirable in some implementations. For example, the system 50 may utilize the tag importance levels 70 to score recommendations identifying recommended media items received from other users in a social recommendation network such as that disclosed in commonly owned and assigned U.S. patent application Ser. No. 11/484,130, entitled P2P NETWORK FOR PROVIDING REAL TIME MEDIA RECOMMENDATIONS, which was filed on Jul. 11, 2006 and has been incorporated herein by reference in its entirety.

As another example, the system 50 may be a server where the communication interface 60 enables the server to communicate with a user at a remote location. More specifically, the system 50 may operate to present the tag representations and/or tag group representations to a user at a remote client device. The system 50 may be connected to the remote client device via a network such as, for example, the Internet. The user may then operate to resize the tag representations and/or tag group representations at the remote client device. As the user performs resizing operations, information is communicated back to the system 50 and received via the communication interface 60. The control system 52 then adjusts the importance levels 70 of the corresponding tags 68 accordingly.

The tags and importance levels discussed herein may be used for any desired purpose. For example, the importance levels of the tags and/or tag groups may be used to search for digital content of interest to the user or recommend digital content to the user. More specifically, the tags may be used to query a local source of content such as the user's local media collection and/or one or more remote sources such as a video sharing website. The results of the search(es) may then be scored or otherwise prioritized as a function of the importance levels assigned to the tags.

As another example, items in the user's media collection or in a playlist of the user may be scored as a function of the importance levels of the tags. More specifically, in order to score a media item, at least one tag matching the media item is identified. The media item is then scored as a function of the importance level, or weight, assigned to the matching tag(s). The media items may then be prioritized or sorted as a function of the scores.

As another example, the tags and importance levels may be used to recommend media items to the user. For example, each of a number of media items available to the user from a media distribution service such as Apple's iTunes® Store may be scored as a function of the importance levels of the tags. The media items having the highest scores may then be recommended to the user.

As a final example, the tags and importance levels may be used for profile matching. Profile matching may be used to identify other users having likes and dislikes similar to the user. The other users having similar likes and dislikes may then be identified as new members or potential new members of the user's social network. The social network may be, for example, a social recommendation network such as that disclosed in commonly owned and assigned U.S. patent application Ser. No. 11/484,130, a social network such as MySpace, or the like.

The exemplary uses of the tags and importance levels given above are not intended to limit the scope of the present invention. Numerous additional uses for the tags and importance levels will be apparent to one of ordinary skill in the art upon reading this disclosure.

Those skilled in the art will recognize improvements and modifications to the preferred embodiments of the present invention. All such improvements and modifications are considered within the scope of the concepts disclosed herein and the claims that follow.

What is claimed is:

1. A method comprising:
presenting a tag representation of a tag to a user, the tag used for describing digital content;
enabling the user to manipulate the tag representation to thereby adjust an importance level assigned to the tag; and
adjusting the importance level assigned to the tag in response to manipulation of the tag representation by the user.

2. The method of claim 1 wherein enabling the user to manipulate the tag representation comprises enabling the user to resize the tag representation to thereby adjust the importance level assigned to the tag.

3. The method of claim 2 wherein enabling the user to resize the tag representation comprises enabling the user to resize the tag representation via a click-and-drag operation.

4. The method of claim 1 wherein the tag representation is a text-based visual representation of the tag.

5. The method of claim 1 further comprising:
enabling the user to select the tag representation to thereby effect presentation of a nested tag representation of a nested tag associated with the tag; and
presenting the nested tag representation to the user.

6. The method of claim 5 further comprising:
enabling the user to manipulate the nested tag representation to thereby adjust an importance level assigned to the nested tag; and
adjusting the importance level of the nested tag in response to manipulation of the nested tag representation.

7. The method of claim 1 wherein the tag is selected from a group consisting of: a music genre tag, a music artist tag, a music album tag, a time period tag, a video genre tag, an actress tag, a participant tag, a keyword tag, a camera tag, a digital content source tag, a date tag, and a location tag.

8. A method comprising:
presenting a tag group representation of a tag group to a user, the tag group comprising a plurality of tags used for describing digital content;
enabling the user to manipulate the tag group representation to thereby adjust an importance level of each of the plurality of tags in the tag group; and
adjusting the importance level of each of the plurality of tags in the tag group in response to manipulation of the tag group representation by the user.

9. The method of claim 8 wherein adjusting the importance level of each of the plurality of tags comprises, for each tag of the plurality of tags, scaling a raw importance level of the tag in response to manipulation of the tag group representation.

10. The method of claim 8 wherein enabling the user to manipulate the tag group representation comprises enabling the user to resize the tag group representation to thereby adjust the importance level of each of the plurality of tags in the tag group.

11. The method of claim 10 wherein enabling the user to resize the tag group representation comprises enabling the user to resize the tag group representation via a click-and-drag operation.

12. The method of claim 10 wherein adjusting the importance level of each of the plurality of tags comprises, for each tag of the plurality of tags, scaling a raw importance level of the tag as a function of a size of the tag group representation.

13. The method of claim 8 wherein the tag group representation is a tag cloud.

14. The method of claim 8 wherein the tag group representation comprises a plurality of tag representations corresponding to the plurality of tags in the tag group.

15. The method of claim 14 further comprising:
enabling the user to manipulate a select tag representation from the plurality of tag representations to thereby adjust the importance level of a corresponding tag of the plurality of tags in the tag group; and
adjusting the importance level of the corresponding tag in response to manipulation of the select tag representation by the user.

16. The method of claim 15 wherein enabling the user to manipulate the select tag representation comprises enabling the user to resize the select tag representation to thereby adjust the importance level of the corresponding tag.

17. The method of claim 16 wherein enabling the user to resize the select tag representation comprises enabling the user to resize the select tag representation via a click-and-drag operation.

18. The method of claim 14 wherein the plurality of tag representations are text-based visual representations corresponding to the plurality of tags in the tag group.

19. The method of claim 14 further comprising:
enabling the user to select a desired tag representation of the plurality of tag representations to thereby effect presentation of a nested tag representation, the nested tag representation representing a nested tag associated with a one of the plurality of tags corresponding to the desired tag representation; and
presenting the nested tag representation to the user.

20. The method of claim 19 further comprising:
enabling the user to manipulate the nested tag representation to thereby adjust an importance level of the nested tag; and
adjusting the importance level of the nested tag in response to manipulation of the nested tag representation.

21. The method of claim 8 wherein each of the plurality of tags is selected from a group consisting of: a music genre tag, a music artist tag, a music album tag, a time period tag, a video genre tag, an actress tag, a participant tag, a keyword tag, a camera tag, a digital content source tag, a date tag, and a location tag.

22. A system comprising:
a display;
a user input device; and
a control system associated with the display and the user input device and adapted to:
present a tag representation of a tag to a user via the display, the tag used for describing digital content;
enabling the user to manipulate the tag representation via the user input device to thereby adjust an importance level of the tag; and
adjust the importance level of the tag in response to manipulation of the tag representation by the user.

23. A server comprising:
a communication interface communicatively coupling the server to a client device; and
a control system associated with the communication interface and adapted to:
present a tag representation of a tag to a user at the client device, the tag used for describing digital content;
enable the user to manipulate the tag representation at the client device to thereby adjust an importance level of the tag; and
adjust the importance level of the tag in response to manipulation of the tag representation by the user at the client device.

24. A system comprising:
a display;
a user input device; and
a control system associated with the display and the user input device and adapted to:
present a tag group representation of a tag group to a user via the display, the tag group comprising a plurality of tags used for describing digital content;
enable the user to manipulate the tag group representation via the user input device to thereby adjust an importance level of each of the plurality of tags in the tag group; and
adjust the importance level of each of the plurality of tags in the tag group in response to manipulation of the tag representation by the user.
